(19) United States
(12) Patent Application Publication
(10) Pub. No.: US 2006/0047645 A1
(43) Pub. Date: Mar. 2, 2006

(54) Method and a system for personal and textbook knowledge management

(76) Inventor: Ike Sagie, Haifa (IL)

Correspondence Address: KATTEN MUCHIN ROSENMAN LLP, 575 MADISON AVENUE, NEW YORK, NY, 10022-2585, US

(21) Appl. No.: 10/932,486

(22) Filed: Sep. 2, 2004

(51) Int. Cl. G06F 17/30

(52) U.S. Cl. 707/4

(57) ABSTRACT

The present invention is a new and efficient means for abstracting answers to questions from a given repository of data, which is either personal knowledge or a textbook. It provides the means for retrieving full answers for complex questions via a PDA-oriented, user friendly interface. The system, which may combine textual as well as other forms of data files (e.g. images, movie and sound files), allows users to retrieve the necessary data from modularly constructed questions using the relevant key words in a simple two click operation. The system is comprised of a set of terms and optionally multimedia objects, a set of relations, a set of meta-relations. Combined they create a set of basic facts and a set of inferred facts. A term is a textual, an object may be text, image, audio, and video files. A relation on term is a phrase that describes any relationship between two terms.

### BACKGROUND

The present invention relates in general to methods of information management, and more particularly to methods of information management in digitally stored data using intelligent fact association.

Personal information, especially if readily accessible on mobile devices, is an important asset to users in all facets of life—both professional and leisure. In present day art there exist a gap between simple, table-like tools such as Microsoft Contact (within Microsoft Outlook), Microsoft Excel and database-like tools such as Microsoft Access and Microsoft SQL Server. The former are easily used by the novice but too rigid for recording and consulting with general knowledge, while the latter require programming skills.

If, for example, a salesman wants to record the fact that Microsoft's telephone number is (555) 824-7666 he could use Microsoft Contact easily. However, to record the fact that Microsoft makes Windows Operating System he needs to add it as a general note, define a custom-field—‘makes’, or use other tools such as Microsoft Excel. As the number of facts grow and with them the number of relations between them, the user quickly gets lost either in scattered notes or in huge, sparsely populated excel tables. Moreover, typically users don't plan in advance all possible relations and need the flexibility to add relations on the fly and frequently change them.

What makes this even harder is the frequent need for inverse facts, such as ‘who makes databases?’ In Microsoft Contact, the only way to retrieve the inverse answer is by searching all contacts for ‘Database’ which would result most likely in finding many irrelevant contacts. Microsoft Excel provides better means for this task by allowing users to sort data appropriately. However, Excel would require the existence of a huge table to include all possible relations for all possible terms, mostly completely irrelevant, or—a complex structure of multiple tables—mimicking database products. Either way the user is faced with a complex solution to a simple need.

There is therefore a need for a means which closes the above-mentioned gap and provides a simple solution for editing, organizing, and consulting personal knowledge. Said means should also fit the constraints of mobile devices such as PDA and smart phones: enable the user to operate the system with minimal typing. In the field of textbook Knowledge readers look up textbooks to find answers to questions. Often people can't phrase precisely the question in mind and as often the answer is not found in a single paragraph in the book. Furthermore, when facts are needed on the move, the reader doesn't have the time or the physical means to engage in interactive and verbose inquiry sessions. The process of looking up a textbook index involves viewing all referenced pages, deciphering only relevant references, and mentally assembling the full answers from multiple pages.

Existing electronic textbooks offer electronic forms of index pages, table of content, and search engines. All of these means are insufficient when trying to retrieve a full answer to a question quickly and efficiently. There is therefore also a need for a means for distilling pure facts from paper and electronic textbooks.

### SUMMARY

The present invention is a data repository structuring method, enabling an easy and efficient query process. The data repository is created according to the following method: defining a set of terms; defining a set of objects; defining a set of relations; defining a set of inverse relations; defining a set of basic facts and set of inverse facts. A single query may link between at least two terms or objects to form facts by associating them using a single relation or an inverse relation. The repository relations are configured by the data structure of the term-relation-term three dimensional facts matrix representing the association between the terms and by data structure of the term-relation-object three dimensional facts matrix representing the association between the terms. The relations are propositional logic types including transitive relations and implied relations.

The structuring of the repository is based on existing electronic text creating an efficient indexing query through the textbook. It is an ongoing process enabling at least one user to create an indexed knowledge database which defines the relations between all object and terms of the user knowledge. The objects are multimedia files and the user is enabled to edit the relations.

The present invention also discloses a data repository management system, enabling an easy and efficient query process which includes the means for enabling the above described method.

### BRIEF DESCRIPTION OF THE DRAWINGS

FIG. 1 is an illustration of the term to term relation data structure according to the present invention;

FIG. 2 is an illustration of the term to object relation data structure;

FIG. 3 is an illustration of the term's window, which lists all the terms of the system according to the preferred embodiment of the present invention;

FIG. 4 is an illustration of the term's window when a single term is expanded to show all its relations;

FIG. 5 is an illustration of the term's window when a single terms and an associated relation are expanded to show all relevant facts;

FIG. 6 is an illustration of the term's window showing an inferred (inverse) fact;

FIG. 7 is an illustration of the pull down window which allows switching between the different windows: Term; Relation; and Object according to the preferred embodiment of the present invention;

FIG. 8 is an illustration of the relation's window;

FIG. 9 is an illustration of the Edit pull down menu enabling the user to edit terms, relations, objects and facts;

FIG. 10 is an illustration of the Term Management Window according to the preferred embodiment of the present invention;

FIG. 11 is an illustration of the Relation Management Window according to the preferred embodiment of the present invention;

FIG. 12 is an illustration of the Object Management Window according to the preferred embodiment of the present invention;

FIG. 13 is an illustration of the Fact Editor Window Step 1: Select Term Window;

FIG. 14 is an illustration of the Fact Editor Window Step 2: Select Relation Window;

FIG. 15 is an illustration of the Fact Editor window Step 3: Select Term Window;

FIG. 16 is an illustration of the Fact Editor window Step 3: Select Object. Window.

### DETAILED DESCRIPTION OF THE PREFERRED EMBODIMENTS

The present invention is a new and efficient means for abstracting answers to questions from a given repository of data, whether it is personal knowledge or a textbook. It provides the means for retrieving full answers for complex questions via a PDA-oriented, user friendly interface. The system, which may combine textual as well as other forms of data files (e.g. images, movie and sound files), allows users to retrieve the necessary data from modularly constructed questions using the relevant key words in a simple two click operation.

The system is comprised of a set of terms and optionally multimedia objects too, a set of relations, a set of meta-relations, a set of basic facts and a set of inferred facts. A term is a textual entity and may be any word or phrase that the user may ask about. For example, ‘Microsoft’ and ‘Windows Operating System’ are terms. An object may take one of many forms, such as text, image, audio, and video files. A relation on term is a phrase that describes any relationship between two terms; a relation on object is a phrase that describes any relationship between a term and an object.

A fact in the form term-relation-term (TRT) is an association of a term with at least one other term according to the relation which connects them. For instance, a TRT fact may be “Microsoft makes Windows Operating System”. Provided that the term A is associated with term B via relation R, and A is also associated with term C via relation R, a fact may comprise a combination of A's relation R to both B and C, for example: “Microsoft makes Windows Operating System and SQL Server”.

A term-relation-object (TRO) fact is comprised of a term and an object which are associated via the appropriate relation, for instance “Bob Newhart” is related to an object named “Bob's Photo” by a “photo” relationship. The appropriate TRO combining them would be “Bob Newhart photo (Bob's Photo)”.

Meta-relations are facts about relations. In the preferred embodiment of the present invention only one type of meta-relation is implemented—an inverse relation. Other embodiments also include propositional logic relation types such as transitive relations and implied relations. An inverse relation reverses the association between term A and B which relate via relation R, and relates them using the inverse relation of R. A new relation is then defined S which may be defined as associate to R via relation “inverse”, for instance provided that R represents relation “makes” and S represents relation “made by” then the meta-fact about these relations is “makes inverse made by”. Thus, the fact “Microsoft makes Windows Operating System” implies the inverse fact: “Windows Operating System made by Microsoft”.

The user need only enter basic facts. The inferred (implied) facts are automatically created by the system, so, using the example above, if the user enters the fact “Microsoft makes Windows Operating System”, the system automatically creates the inverse fact “Windows Operating System made by Microsoft”.

Each association of a single term to a relation represents a question. For example, associating a term to the relation ‘makes’ represents the question: “what does (term) make?” Relevant questions for a term are those relations that appear in facts about the term. A full answer to a question is the set of all the facts about the term which include the relation that represent the question.

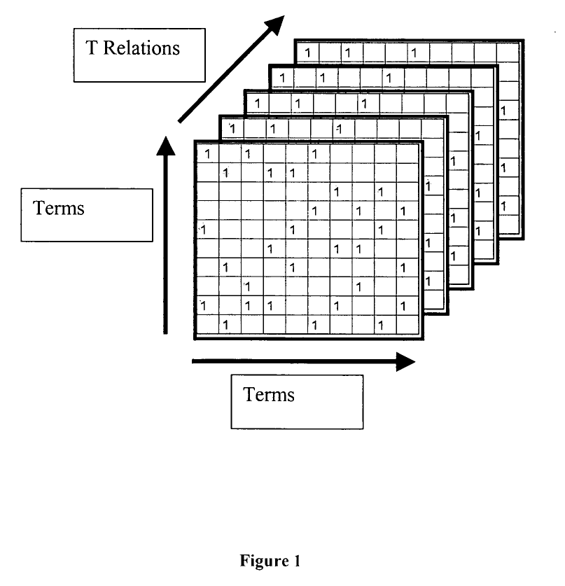

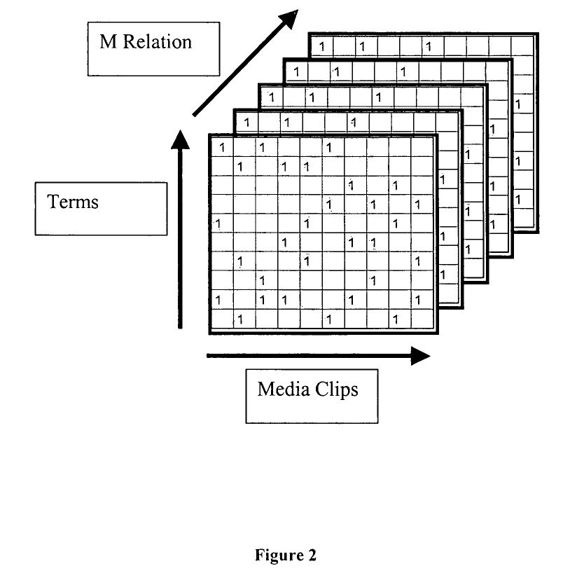

FIG. 1 and FIG. 2 illustrate the System data structures, which is the basis for the System's algorithms. FIG. 1 illustrates the TRT three dimensional facts matrix. It is a three-dimensional sparse binary matrix: the “L Term” dimension represents the term of the left hand side of a fact; the “R Term” dimension represents the term of the right hand side of a fact; and the “Relation” dimension represents the relation that ties the left hand term to the right hand term.

A ‘1’ in position T(i,j,k) represents the fact that term(i) is related to term(j) through relation (k). Following are several algorithms which may derive from this representation. The questioned which may be composed for term(i) are “given term (i) what are the possible questions (i.e. relations)?” In order to calculate the answer for every relation (k) an “OR T(i,*,k)” and if the result equals “1” then the relation (k) is added to the list of questions.

The algorithm for answering the question “given term (i) and relation (k) (i.e. question), what are the answers (i.e. term (j))?” For calculating the answer for this question for every term (1), if T(i,j,k)=1 then term (j) is added to the list of answers. A third algorithm answers the question “given relation (k) (i.e. question) what are the terms for which this question pertain?” It is answered when for each term (i) “OR T(i,*,k)” is calculated and if the result is 1 than add term (i) to the list of terms.

1. The fourth algorithm includes the answer to the question “given a relation (k) (i.e. question) and a term (i) that pertains to it, what is the answer?” To answer this question for each term (j), if T(i,j,k) is equal to “1” then term (j) is added to the list of terms.

FIG. 2 illustrates the TRO three dimensional fact matrix. The same algorithms may derive from TRO facts only right hand terms are replaced by right hand objects. TABLE 1 illustrates the Terms table. This table assigns a phrase to each term.

TABLE 1

| # | Term |
|---|---|
| 1 | Phrase for term 1 |
| 2 | Phrase for term 2 |
| 3 | . . . |

TABLE 2 illustrates the Term Relations Table. This table assigns a phrase to each term relation. The system holds an initial set of common term relations and the user may add to it.

TABLE 2

| # | T-Relation |
|---|---|
| 1 | Phrase for Relation 1 |
| 2 | Phrase for Relation 2 |
| 3 | . . . |

TABLE 3 illustrates the Object Relations Table. This table assigns a phrase to each object relation.

TABLE 3

| # | Object Relation |
|---|---|
| 28 | Phrase for Relation 28 |
| 29 | Phrase for Relation 29 |
| 30 | . . . |

TABLE 4 illustrates the Inverse Relations Table. This table ties each relation to its inverse relation.

TABLE 4

| Relation | Inverse Relation |
|---|---|
| 1 | 2 |
| 4 | 7 |
| . | . |
| . | . |
| . | . |

TABLE 5 illustrates the Object Table. This table contains the name, media, and location of each multimedia object file. The location takes the form of a Universal Resource Locator.

TABLE 5

| # | Media Type | File Locator |
|---|---|---|
| 1 | Image | Locator for object 1 |
| 2 | Text | Locator for object 2 |
| 3 | Image | Locator for object 3 |
| 4 | . . . | . . . |

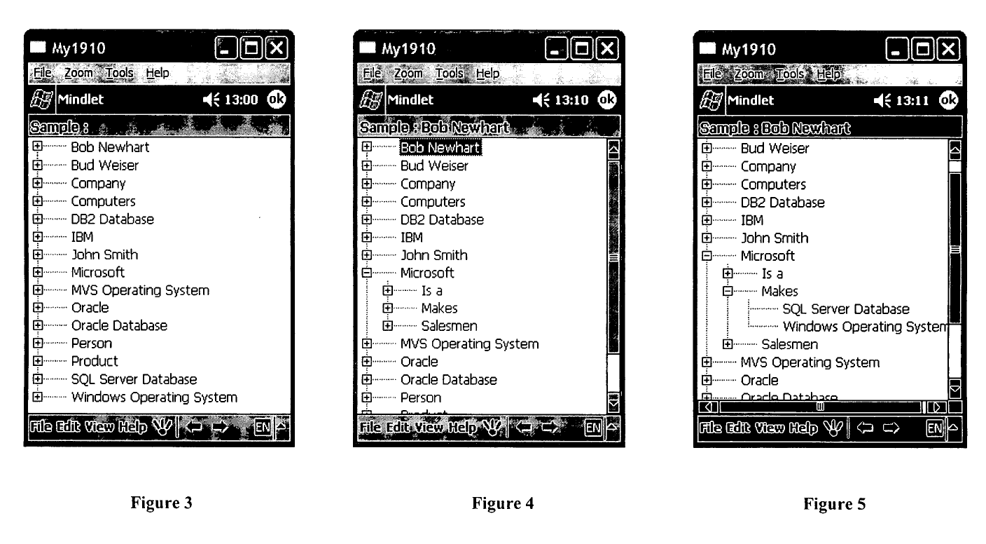

Following is an explanation of the system's functionality and its user interface as illustrated in FIG. 3 to FIG. 16. There are two operational modes for the user: as a reader and as an author. FIG. 3 to FIG. 8 are examples for the system's reader user interface. In the reader mode users may investigate the facts which are stored in the system and issue answers to questions, but they may not edit the data. FIG. 3 illustrates the opening window which presents the index of the system's available terms. As illustrated in FIG. 4, expanding the term “Microsoft” shows the list of relations, in this case it is “is a”, “makes” and “salesmen”. Expanding the relation's list provides the list of terms which are connected to the original term via the current relation. As illustrated in FIG. 5, in the present example expanding the relation “makes” reveals the terms “SQL Server Database” and “Windows Operating System”.

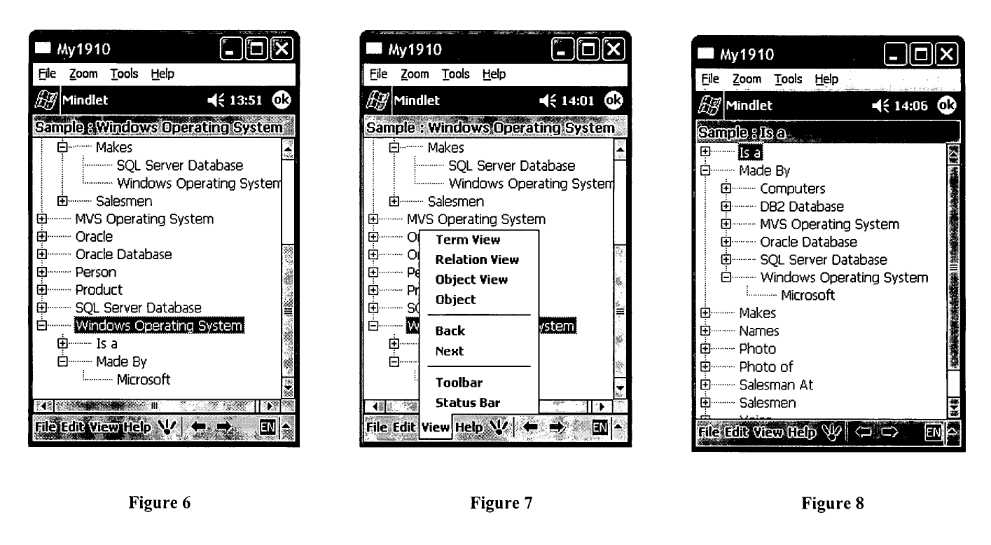

This is a simple example for showing how the system provides the users with means for receiving answers to questions. The user may then continue the investigation by exploring the new terms and their relations. Clicking on the term “Windows Operating System”, for instance reveals, as illustrated in FIG. 6, its relations, including ‘made by”—the inverse relation of “makes”. Thus, as illustrated in FIG. 3 the list includes the basic as well as the inferred facts: that “Microsoft makes Windows Operating System” and that “Windows Operating System made by Microsoft”.

In addition to Term Window the system allows two other windows: Relation Window and Object Window listing all the relations and objects respectively. FIG. 7 illustrates how a user may switch between the different windows.

The Relation Window, as illustrated in FIG. 8, lists all the relations in the system. Expanding a specific relation, such as “made by” reveals all facts that include the relation “made by”. Expanding the term “Microsoft” under the relation “Made By” reveals the fact “Windows Operating system Made By Microsoft”.

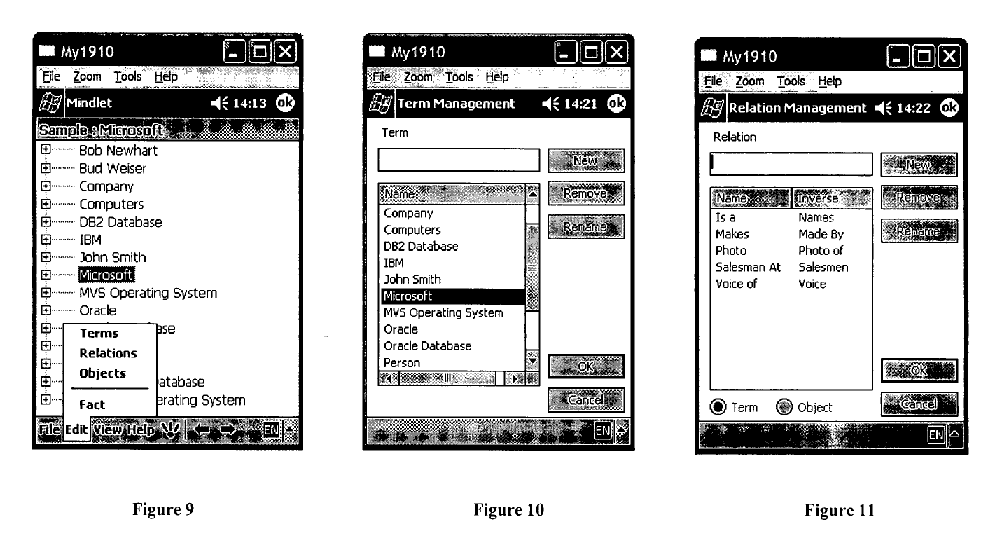

FIG. 9 to FIG. 16 illustrate examples for the system's user interface when the user is in an author's operational mode. The author operational mode is similar to the reader mode but it also includes the edit option which allows the user to edit the constituents of a given data set. The author can also play the role of a reader to test the edited system. Thus, the main window in the author mode is the same Term Window, as illustrated in FIG. 3. The edit menu allows users to edit a term, a relation, an object or a fact as shown in FIG. 9.

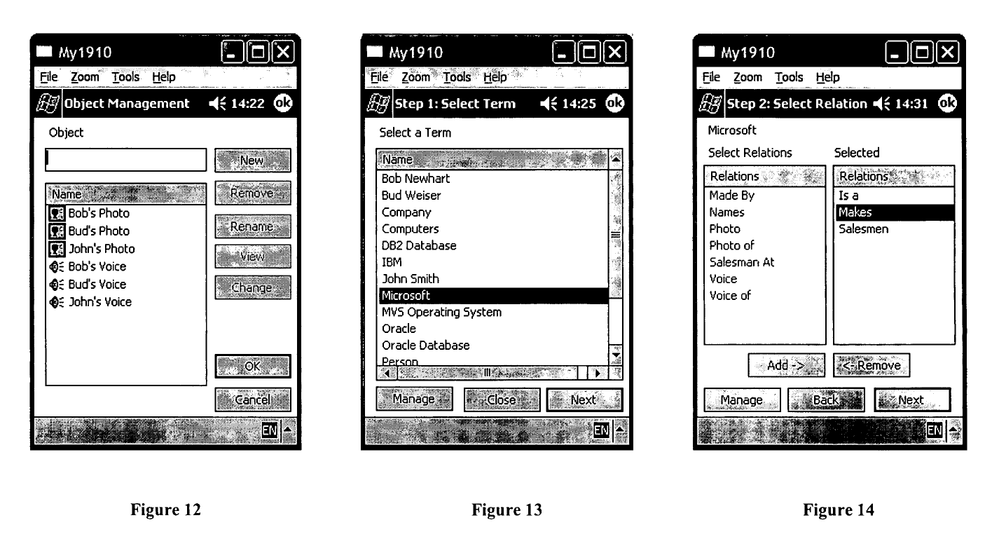

As illustrated in Figures FIG. 10, and FIG. 11 the term and the relation editors allow adding, removing and renaming of terms and relations. In the editing relations window the user may also define the relevant meta-relations. In the preferred embodiment the only meta-relation implemented is the inverse meta-relation, but other embodiments may include propositional logic types such as transitive relations and implied relations. The object editor window, which is illustrated in FIG. 12, allows adding media files, such as images, video clips or sound files to the system. Through this window the users may add, remove, rename and display the multimedia object files.

The fact editor window, which is at the core of the system, allows modification, removal, and adding of new facts to the system.

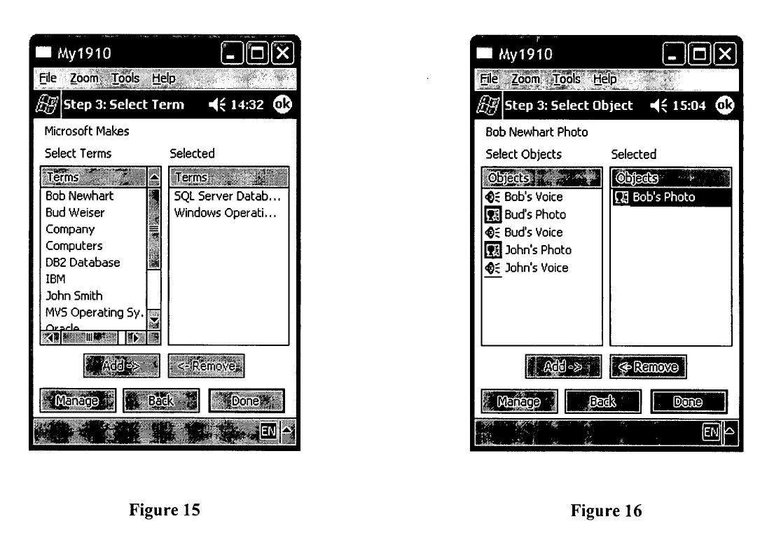

Fact editing is always done in three steps: first, the users select a left-hand-side term (FIG. 13), then they may select a relation—a term relation or object relation (FIG. 14), and finally they may select a right-hand-side term or relation (FIG. 15, FIG. 16).

In FIG. 13 the term “Microsoft” has been selected for left-hand-side term. Clicking on the Next button will move the user to the Step 2 window as illustrated in FIG. 14. In this window the user can select or de-select relations associated with the term. Then, clicking on the Next button will move the user to the window of Step 3 as illustrated in FIG. 15 and FIG. 16. In this window the user can associate right-hand-side terms or objects to complete the fact.

In every step along the process the user can click on the Manage buttons to add new terms, relations, or objects to the system if they are not found among existing entries.

What is claimed is:

1. A data repository structuring method, enabling an easy and efficient query process, said data repository created according to the following method
defining a set of terms;
defining a set of objects;
defining a set of relations;
defining a set of inverse relations;
defining a set of basic facts and set of inverse facts,
wherein a single query may link between at least two terms or objects to form facts by associating them using a single relation or an inverse relation.

2. The method of claim 1 wherein the repository relations are configured by data structure of the term-relation-term three dimensional facts matrix representing the association between the terms.

3. The method of claim 1 wherein the repository relations are configured by data structure of the term-relation-object three dimensional facts matrix representing the association between the terms.

4. The method of claim 1 wherein the relations are propositional logic types including transitive relations and implied relations.

5. The method of claim 1 wherein the structuring of the repository is based on existing electronic text creating an efficient indexing query through the textbook.

6. The method of claim 1 wherein the structuring of the repository is an ongoing process enabling at least one user to create an indexed knowledge database which define the relations between all object and terms of the user knowledge.

7. The method of claim 1 wherein the objects are multimedia objects.

8. The method of claim 1 wherein the user is enabled to edit the relations.

9. A data repository management system, enabling an easy and efficient query process, including the following:
Module for defining and editing a set of terms:
Module for defining and editing set of objects;
Module for defining and editing set of relations;
Module for defining and set of inverse relations;
Module for defining a set of basic facts and set of inverse facts,
wherein a single query may link between at least two terms or objects to form facts by associating them using a single relation or an inverse relation.

10. The system of claim 9 wherein the repository relations are configured by the data structure of the term-relation-term three dimensional facts matrix representing the association between the terms.

11. The system of claim 9 wherein the repository relations are configured by data structure of the term-relation-object three dimensional facts matrix representing the association between the terms.

12. The system of claim 9 wherein the relations are propositional logic types including transitive relations and implied relations.

13. The system of claim 9 wherein the management of the repository is based on existing electronic text creating an efficient indexing query through the textbook.

14. The system of claim 9 wherein the management of the repository is an ongoing process enabling at least one user to create an indexed knowledge database which defines the relations between all object and terms of the user knowledge.

15. The system of claim 9 wherein the objects are multimedia objects.

16. The system of claim 9 wherein the user is enabled to edit the relations.
